(19) United States
(12) Patent Application Publication
(10) Pub. No.: US 2015/0209816 A1
(43) Pub. Date: Jul. 30, 2015

(54) TIRE LUBRICATOR DEVICE

(71) Applicant: Kabushiki Kaisha Kobe Seiko Sho (Kobe Steel, Ltd.), Hyogo (JP)

(72) Inventors: Hajime Tanaka, Takasago-shi (JP); Munenori Soejima, Takasago-shi (JP)

(73) Assignee: Kabushiki Kaisha Kobe Seiko Sho (Kobe Steel, Ltd.), Hyogo (JP)

(21) Appl. No.: 14/419,838

(22) PCT Filed: Sep. 9, 2013
(86) PCT No.: PCT/JP2013/005334

§ 371 Date: Feb. 5, 2015

(30) Foreign Application Priority Data
Sep. 28, 2012 (JP) 2012-216853

(51) Int. Cl. B05C 1/02; G01M 17/02; B05C 11/00

(52) U.S. Cl. CPC B05C 1/027; B05C 11/00; G01M 17/021

(57) ABSTRACT

This lubricator device includes an upper roller brush unit that comes into contact with a bead section on the upper side of a tire rotated about a vertical axis and applies a lubrication liquid, a lower roller brush unit that comes into contact with a bead section on the lower side of the tire and applies the lubrication liquid, a lubricator body, and a brush movement unit that connects the upper roller brush units to the lubricator body, and moves the upper roller brush unit and the lower roller brush unit in contact with and away from the tire. The brush movement unit includes a link mechanism that brings the upper roller brush unit close to the tire while moving the upper roller brush unit downward and brings the lower roller brush unit close to the tire while moving the lower roller brush unit upward.

### TECHNICAL FIELD

The present invention relates to a tire lubricator device.

### BACKGROUND ART

Conventionally, at the time of testing a tire, the tire is installed in a rim of a tire testing machine and a rotation test is performed. In order to smoothly attach and detach the tire to and from the rim, a lubrication liquid (lubricant) is applied to bead sections of the tire serving as a test object. The lubrication liquid is applied in a lubricator device provided in a tire testing line.

Techniques relating to the lubricator device are disclosed in Patent Documents 1 and 2.

For example, a lubricator device described in Patent Document 1 has a carrying means that mounts a tire so that an axis of the tire is placed in a vertical axis posture and carries the tire in the predetermined direction, a positioning means that positions the tire at a predetermined position of the carrying means, a pivoting means that pivots the tire about the axis thereof at the positioning position, and an applying means that applies a lubricant to bead sections of the pivoted tire. This applying means has an application roller that applies the lubricant to the bead sections of the tire. In a case of application, the application roller is raised and inserted into a center hole of the tire, and next, the application roller is pressed along the horizontal direction. Thereby, the lubricant can be applied to the bead sections of the tire to be pivoted by the pivoting means.

A lubricator device described in Patent Document 2, as shown in FIGS. 2 and 5 of the document, applies a lubricant to bead sections of a tire by pressing an application roller raised by actuation of an elevating air cylinder onto the bead sections of the tire.

In a case of applying the lubrication liquid, it is becoming clear that a place and a position where this lubrication liquid is applied are very important.

For example, the place where the lubrication liquid is applied includes only radially inner end surfaces of the bead sections shown in FIG. 10 (parts denoted by the reference numerals 11 of FIG. 10), lubrication by the lubrication liquid becomes insufficient. Thus, there is sometimes a case where when a uniformity test is performed after application, the tire cannot surely be fitted into the rim and measurement precision of the tire test is deteriorated. Therefore, the place where the lubrication liquid is applied is preferably set in a wide range.

However, in the lubricator devices of Patent Document 1 and Patent Document 2, the application roller is inserted into a space formed in a center part of the tire in parallel to the direction in which the rotation axis of the tire extends, and then the application roller is horizontally moved to the radially outer side of the tire and the application roller is pressed onto the bead sections. Therefore, by the application roller, the lubrication liquid is applied only to the radially inner end surfaces of the bead sections (reference numerals 11 of FIG. 10).

Therefore, in the lubricator devices of Patent Document 1 and Patent Document 2, although the lubrication liquid can be applied to the radially inner end surfaces of the bead sections, the precipitous surfaces toward the vertical direction, the lubrication liquid cannot be applied to side end surfaces of the bead sections (upper and lower end surfaces of the bead sections, the parts denoted by the reference numerals 12 of FIG. 10), and there is sometimes a case where lubrication is not sufficiently performed.

### CITATION LIST

### Patent Document

Patent Document 1: JP 8-257460 A

Patent Document 1: JP 4426940

### SUMMARY OF THE INVENTION

An object of the present invention is to provide a tire lubricator device capable of applying a lubrication liquid not only to radially inner end surfaces of bead sections but also to side end surfaces of the bead sections, so that a tire test can be performed with high precision in a state where lubrication is sufficiently performed.

A tire lubricator device of the present invention is characterized by including an upper roller brush unit that comes into contact with a bead section on the upper side of a tire rotated about a vertical axis and applies a lubrication liquid, a lower roller brush unit that comes into contact with a bead section on the lower side of the tire and applies the lubrication liquid, a lubricator body, and a brush movement unit that connects the upper roller brush unit and the lower roller brush unit to the lubricator body, and moves the upper roller brush unit and the lower roller brush unit in contact with and away from the tire, wherein the brush movement unit has a link mechanism that brings the upper roller brush unit close to the tire while moving the upper roller brush unit downward and brings the lower roller brush unit close to the tire while moving the lower roller brush unit upward.

### BRIEF DESCRIPTION OF DRAWINGS

FIG. 1 is a plan view of a tire testing line in which a lubricator device according to an embodiment of the present invention is provided.

FIG. 2 is a side view of the testing line of FIG. 1.

FIG. 3 is a view showing the entire configuration of the lubricator device of FIG. 2, the view showing a state where brush units are away from bead sections of a tire.

FIG. 4 is a view showing the entire configuration of the lubricator device of FIG. 2, the view showing a state where the brush units are in contact with the bead sections of the tire.

FIG. 5(a) is a sectional view of an upper roller brush unit provided in the lubricator device, and FIG. 5(b) is a sectional view of a lower roller brush unit.

FIG. 6(a) is an enlarged view in which a contact point of the bead section and the roller brush unit in the lubricator device of FIG. 3 is enlarged, and FIG. 6(b) is an enlarged view of a lubricator device of a reference example.

FIG. 7 is a sectional view of the lubricator device of FIG. 3 at a lowered position.

FIG. 8 is a sectional view of the lubricator device of FIG. 3 in a state where the lubricator device is away from the bead sections of the tire.

FIG. 9 is a sectional view of the lubricator device of FIG. 3 in a state where the lubricator device is in contact with the bead sections of the tire.

FIG. 10 is an enlarged view of the bead sections of the tire.

### DESCRIPTION OF EMBODIMENTS

A lubricator device 1 according to an embodiment of the present invention is provided in a tire testing line 2 in which a tire test for uniformity, dynamic balance, or the like is performed. The lubricator device is a device that applies a lubrication liquid (lubricant) to a tire T to which the tire test is performed. Specifically, since the tire test for uniformity, dynamic balance, or the like is performed in a state where the tire T is installed in a rim (not shown) of a tire testing machine 50, the lubrication liquid is applied preferably before the tire T is installed in the rim.

When the lubrication liquid is applied, the rim and the like are lubricated by the lubrication liquid. Thereby, at the time of the tire test, the tire T can be smoothly installed in the rim and the tire T can be smoothly removed from the rim. An installing state of the tire T in the rim is stabilized, so that the tire test can be performed under the same test condition and the tire test can be performed with high precision. Thus, in the tire testing line 2, the lubrication liquid is applied to the tire T in advance by using the lubricator device as in the present embodiment.

Hereinafter, before describing the lubricator device 1 of the present embodiment, the tire testing line 2 in which the lubricator device 1 is provided will be described in detail at first.

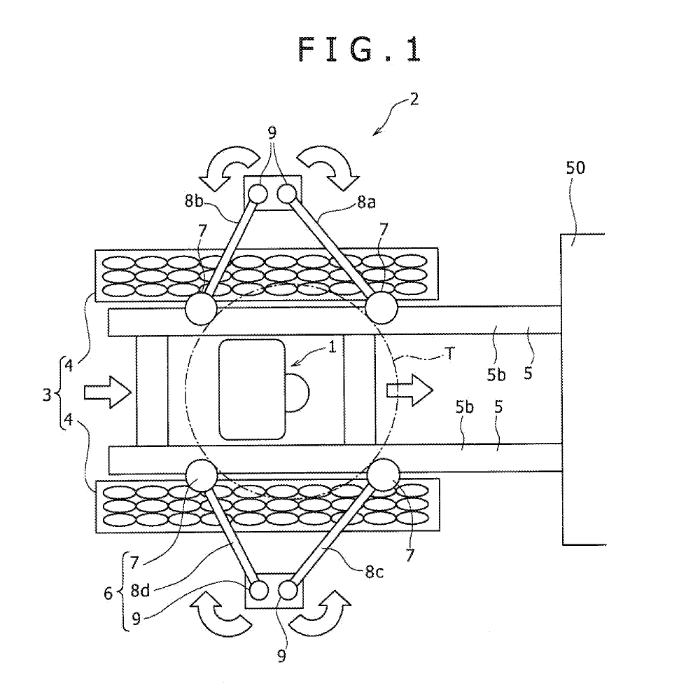

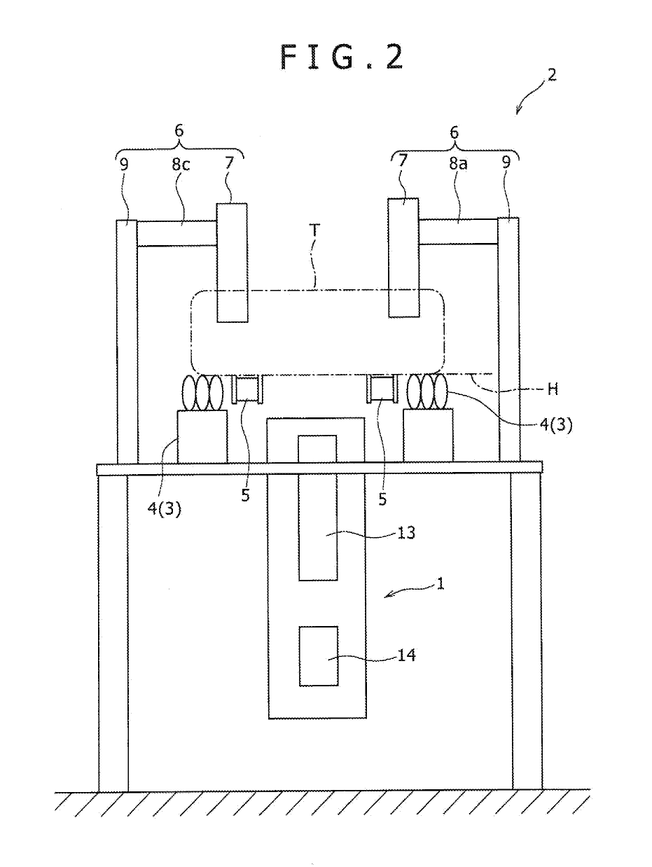

As shown in FIGS. 1 and 2, in the tire testing line 2, belt conveyors 5 that transport the tire T toward the tire testing machine 50, and a free roller conveyor 3 for rotating the tire are provided. The free roller conveyor 3 is made up of one conveyor lane 4 and one conveyor lane 4 placed horizontally and provided so as to have a gap between the conveyor lanes in the left and right direction (up and down direction in FIG. 1).

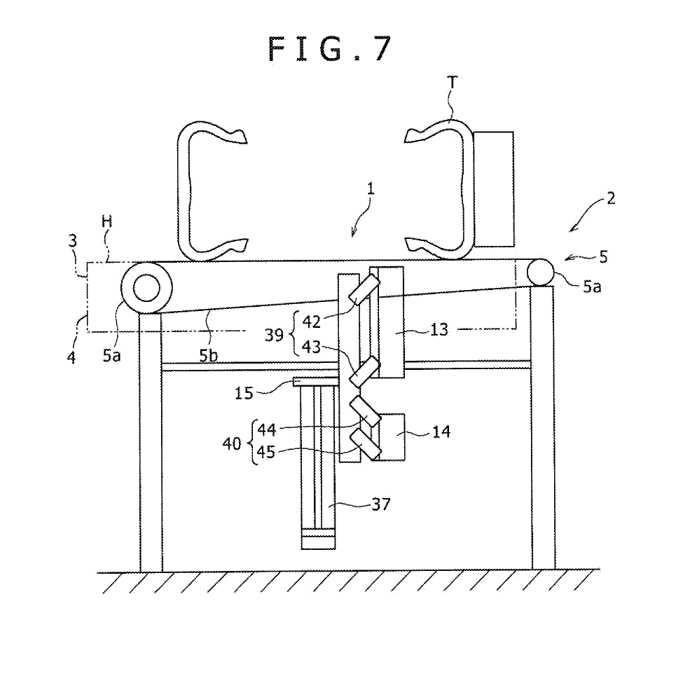

These conveyor lanes 4 have for example a configuration that a large number of free rollers rotatable about axes set in the left and right direction for example are placed along the horizontal direction. The conveyor lanes 4 can be moved horizontally while the tire T mounted on the conveyor lanes 4 remains in a state where the tire is lying on its side. In the tire testing line 2, on the further inner side of the two conveyor lanes 4, 4 placed on the left and right sides, the pair of left and right belt conveyors 5 is provided along the conveyor lanes 4. Each of the belt conveyors 5 is, for example as shown in FIG. 7, formed by letting an endless belt 5b loop over pulleys 5a placed side by side along the conveyor lane 4. By rotating the endless belts 5b of the belt conveyors 5, the tire T mounted on both the endless belts 5b and the conveyor lanes 4 can be carried forward in the horizontal direction.

Further, the tire testing line 2 also includes a handling mechanism 6. This handling mechanism 6 can position the tire T at a predetermined position on the free roller conveyor 3 by bringing gripping rollers 7 close to the tire T mounted on the free roller conveyor 3 in a state where the tire is lying on its side from four directions of the front left side, the front right side, the rear left side, and the rear right side, and pressing the gripping rollers 7 onto an outer peripheral surface of the tire T from the four directions.

Specifically, this handling mechanism 6 has two arm members 8a, 8b provided on the further left side of the conveyor lane 4 on the left side (that is, on the upper side of FIG. 1). Further, the handling mechanism 6 has two arm members 8c, 8d provided on the further right side of the conveyor lane 4 on the right side (that is, on the lower side of FIG. 1). In fact, the handling mechanism 6 has the two arm members 8a, 8b and the two arm members 8c, 8d (four arm members in total) on the outer sides of the conveyor lanes 4. The arm members 8a to 8d are elongated bodies having length which is about substantially half length of the free roller conveyor 3.

On the outer side adjacent to each of the conveyor lanes 4, two rotation shaft sections 9 whose axes are set in the vertical direction (vertical direction on the paper plane of FIG. 1) are provided along the conveyor lane 4. Base ends of the two arm members 8a, 8b and the two arm members 8c, 8d are supported on the rotation shaft sections 9 so as to be rotated respectively about the rotation shaft sections 9. The gripping rollers 7 for nipping a tread surface of the horizontally arranged tire T from the four directions are provided in front ends of the arm members 8a to 8d. Any of the gripping rollers 7 is attached so as to be rotatable about an axis set in the vertical direction (vertical direction on the paper plane of FIG. 1).

One arm member 8a of the two arm members 8a, 8b (arm members on the upper side of FIG. 1) adjacent to the conveyor lane 4 on the left side is directed forward along the carrying direction of the tire T, and the other arm member 8b is directed rearward along the carrying direction of the tire T. The two arm members 8c, 8d (arm members on the lower side of FIG. 1) adjacent to the conveyor lane 4 on the right side are arranged as well as the above two arm members 8a, 8b.

Any of these four arm members 8a to 8d can be oscillated about the rotation axis (rotation shaft section 9) set in the vertical direction (vertical direction on the paper plane in FIG. 1) on the free roller conveyor 3 along a horizontal plane. Following oscillation of the arm members 8, the gripping rollers 7 provided in the front ends of the arm members 8 can be brought close to the outer peripheral surface of the tire T or away from the outer peripheral surface of the tire T. Any of the gripping rollers 7 is attached so as to be rotatable about the axis set in the vertical direction. The tire T positioned at the predetermined position on the free roller conveyor 3 can be freely rotated about an up-down axis.

When rotation drive force is given to the tire T positioned at the predetermined position on the free roller conveyor 3 in such a way by using a tire pivoting unit (not shown), the tire T is rotated on the free roller conveyor 3. In the tire testing line 2, the lubrication liquid is applied to the rotating tire T by using the lubricator device 1 to be described in detail below.

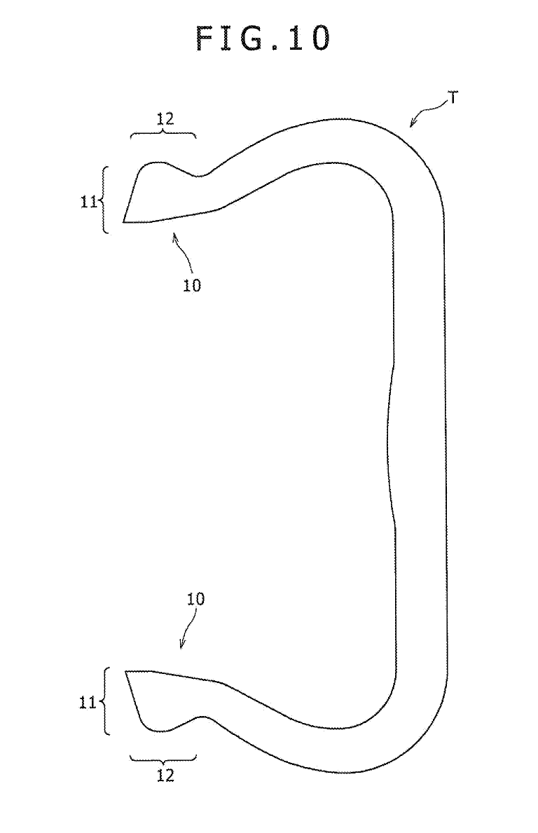

The tire lubricator device 1 of the present embodiment can apply the lubrication liquid not only to radially inner end surfaces 11 of bead sections 10 but also to side end surfaces 12 (surfaces continuing to a side wall) of the bead sections 10. Specific positions of the radially inner end surfaces 11 of the bead sections 10 and the side end surfaces 12 of the bead sections 10 are shown in FIG. 10.

The lubricator device 1 of the present embodiment is arranged between the left and right belt conveyors 5, 5 provided in the above-described tire testing line 2, and arranged at the same position on the plane as the tire T positioned on the free roller conveyor 3. In a case where no lubrication is performed, the lubricator device 1 is accommodated on the lower side of a tire carrying plane H on the free roller conveyor 3. In a case where lubrication is performed, the lubricator device is raised upward from the tire carrying plane H and an upper roller brush unit 13 and a lower roller brush unit 14 to be described later are moved forward from the raised position.

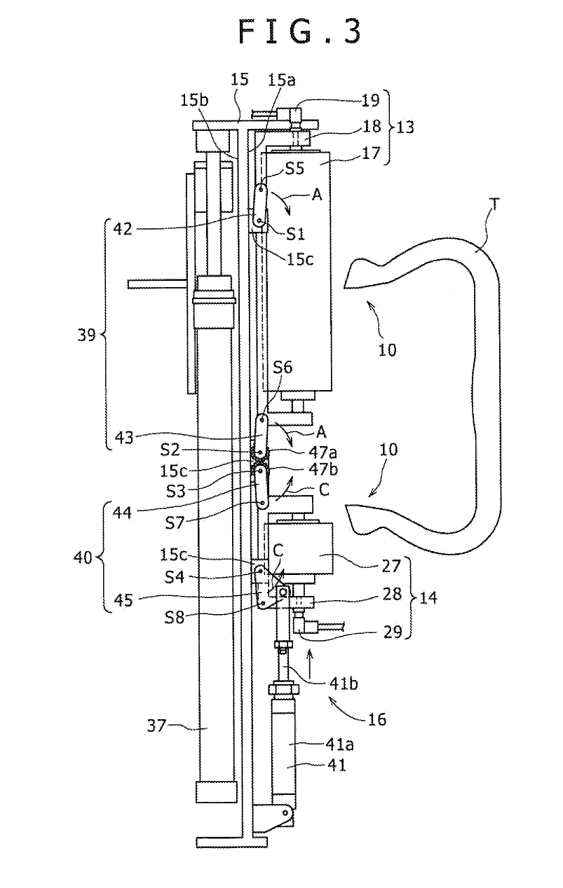

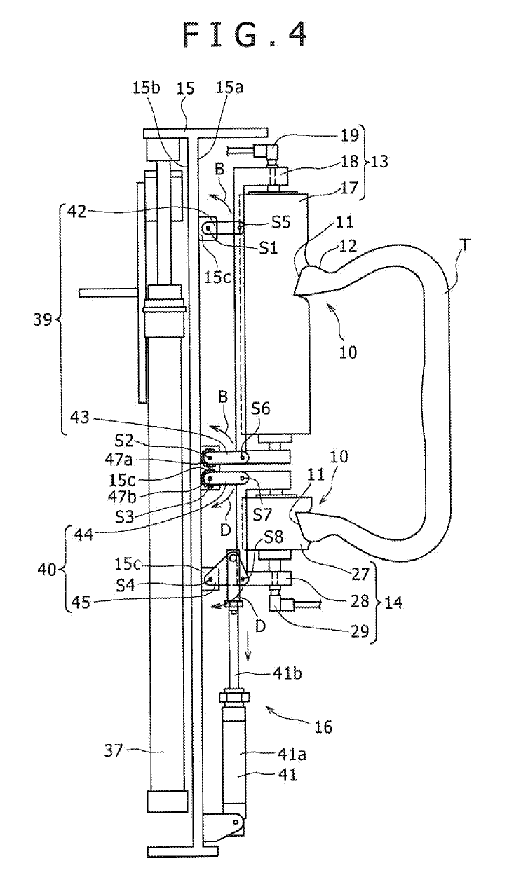

Next, by using FIGS. 3 and 4, a configuration of the lubricator device 1 will be described at first.

It should be noted that FIG. 3 shows a structure of the lubricator device 1 in a state before the upper and lower roller brush units 13, 14 are moved toward the side of the tire T, and FIG. 4 shows a structure of the lubricator device 1 in a state after the upper and lower roller brush units 13, 14 are moved toward the side of the tire T.

As shown in FIGS. 3 and 4, the tire lubricator device 1 of the present embodiment has the upper roller brush unit 13 that comes into contact with the bead section 10 on the upper side of the tire T rotated about the vertical axis and applies the lubrication liquid, and the lower roller brush unit 14 that comes into contact with the bead section 10 on the lower side of the tire T and applies the lubrication liquid. Further, the lubricator device 1 includes a lubricator body 15, and a brush movement unit 16 that connects the upper roller brush unit 13 and the lower roller brush unit 14 to the lubricator body 15, and moves the upper roller brush unit 13 and the lower roller brush unit 14 in contact with and away from the tire T.

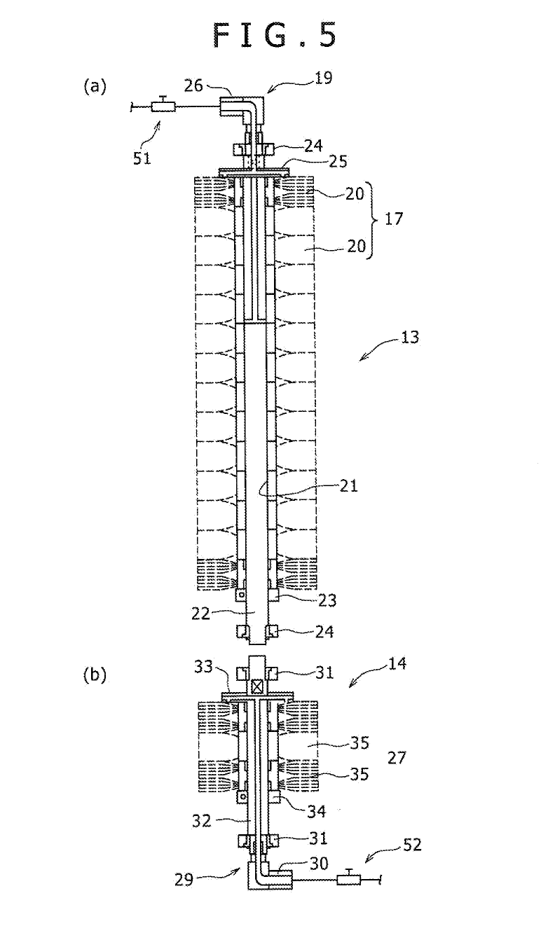

As shown in FIGS. 3 to 5(a), the upper roller brush unit 13 includes a brush body 17 (upper brush body) formed in a cylindrical shape about an axis set in the vertical direction (up and down direction in FIGS. 3 to 5(a)), a brush frame 18 that rotatably supports this brush body 17 about the axis set in the vertical direction, and a supply unit 19 that supplies the lubrication liquid to the brush body 17.

The brush body 17 forming the upper roller brush unit 13 has a cylindrical body elongated in the vertical direction. On an outer peripheral surface of this cylindrical body, brush bristles to come into contact with a surface of the tire T (specifically, a surface of the bead section 10 on the upper side of the tire T) and apply the lubrication liquid are planted over the entire circumference. With this configuration, the brush body 17 can come into contact with the bead section 10 on the upper side of the tire T and apply the lubrication liquid.

Specifically, the brush body 17 is formed into a cylindrical body shape by laminating a plurality of (fourteen, in the present embodiment) brush rings 20 having an annular (short tube shape) outer appearance along the vertical direction.

On outer peripheral surfaces of the brush rings 20, flexible brush bristles are planted over the entire circumference. In the center of the brush rings 20, a through hole 21 passing through the brush rings 20 in the vertical direction is formed. A shaft 22 is inserted into this through hole 21 along the vertical direction, and by this shaft 22, the plurality of brush rings 20 can be fixed in a state where the shaft passes through the brush rings.

It should be noted that on the lowermost side of the plurality of brush rings 20, a retaining member 23 that suppresses the brush rings 20 from dropping off the shaft 22 is provided.

As described above, the brush body 17 is formed as a laminated body of the plurality of brush rings 20. Thus, only the brush rings 20 to be not continuously used anymore due to wear or the like are required to be replaced, so that only minimum replacement is required in comparison to a case where the entire brush body 17 is replaced at once. Therefore, cost and trouble for replacement of the brush body 17 can be reduced to a great extent.

The brush frame 18 forming the upper roller brush unit 13 is a member in a shape formed by using an oblong plate directed in the front and rear direction and provided in a standing manner along the vertical direction and bending an upper end and a lower end of this oblong plate forward at right angle (in a substantially U shape in a side view seen in the left and right direction). Bearing sections 24 that support the shaft 22 of the brush body 17 rotatably about the vertical axis are respectively provided in the upper end and the lower end of this brush frame 18. The above-mentioned brush body 17 is supported by the brush frame 18 rotatably about the vertical axis. When the brush body 17 is rotatably supported by the brush frame 18 in such a way, at the time of applying the lubrication liquid, the brush body 17 itself is rotated, so that wear of the brush bristles can be suppressed.

The supply unit 19 that supplies the lubrication liquid supplies the lubrication liquid to the brush body 17 from a lubrication liquid tank (not shown) or the like in which the lubrication liquid is stored. The supply unit 19 has a disc shape spraying member 25 arranged on the upper side of the above-described brush body 17 to spray the lubricating liquid, and a lubrication pipe 26 (upper pipe) that guides the lubrication liquid to this spraying member 25 from the upper side. An interior of the spraying member 25 is hollow so that the lubrication liquid can be circulated. The spraying member 25 includes a plurality of spraying ports provided in the circumferential direction on a lower surface to be brought into contact with the brush body 17, the spraying ports through which the lubrication liquid is sprayed. The lubrication pipe 26 is provided so as to pass through from the upper side of the bearing section 24 provided in the upper end of the brush frame 18 and further pass through the bearing section 24 in the vertical direction. Via this lubrication pipe 26, the lubrication liquid can be directly supplied to the interior of the spraying member 25. The lubrication liquid supplied to the interior of the spraying member 25 in such a way is supplied to the brush body 17 while being divided and distributed into the plurality of spraying ports. The lubrication liquid supplied to the brush body 17 is soaked into an interior of the brush body 17 through between the brush bristles, so that the lubrication liquid is uniformly spread over the brush body 17 substantially entirely in the vertical direction.

As shown in FIGS. 3 to 5(a), the lower roller brush unit 14 also includes a brush body 27 (lower brush body) formed in a cylindrical shape about an axis set in the vertical direction, a brush frame 28 that rotatably supports this brush body 27 about the axis in the vertical direction, and a supply unit 29 that supplies the lubrication liquid to the brush body 27 as well as the upper roller brush unit 13.

This lower roller brush unit 14 is formed to be shorter than the upper roller brush unit 13 in the vertical direction. Arrangement of members in the lower roller brush unit 14 is such arrangement that the arrangement of the upper roller brush unit 13 is reversed in the vertical direction. The brush body 27 has such height that the brush body can come into contact with the bead section 10 on the lower side of the tire T and apply the lubrication liquid.

That is, in the lower roller brush unit 14, the lubrication liquid is supplied from the lower side of the brush body 27. A lubrication pipe 30 (lower pipe) is provided so as to pass through a bearing section 31 provided in a lower end of the brush frame 28 in the vertical direction. The lubrication pipe 30 once guides the lubrication liquid supplied from the further lower side of the brush frame 28 to the upper side of the brush frame 28. After that, via this lubrication pipe 30, the lubrication liquid is carried from a lower end of the brush body 27 to an upper end through an interior of a shaft 32, and then supplied from the upper side of the brush body 27 toward the lower side while being distributed in an interior of a spraying member 33.

It should be noted that a retaining member 34 of the brush body 27 provided in the lower roller brush unit 14 is arranged on the lower side of the brush body 27 as well as that of the upper roller brush unit 13, so as to suppress a plurality of (three, in the present embodiment) brush rings 35 from dropping off.

In each of the lubrication pipe 26 provided in the upper roller brush unit 13 and the lubrication pipe 30 provided in the lower roller brush unit 14, a flow regulating valve (not shown) that regulates a supply amount of the lubrication liquid flowing through each of the pipes may be provided. When such flow regulating valves are provided, the lubrication liquid can be supplied to the upper roller brush unit 13 and the lower roller brush unit 14 respectively independently, so that a lubricating state of each of the roller brush units 13, 14 can be adjusted individually.

The lubricator body 15 is a plate shape member provided in a standing manner along the vertical direction. On the side of a front surface 15a of this lubricator body 15, the above-described upper roller brush unit 13 and the lower roller brush unit 14 are attached side by side in the up and down direction on the same axis. To the lubricator body 15, the upper roller brush unit 13 and the lower roller brush unit 14 are attached via the brush movement unit 16 to be described later.

On a rear surface of the lubricator body 15, an air cylinder 37 that elevates the lubricator body 15 in the vertical direction is arranged.

The lubricator device 1 of the present embodiment includes the brush movement unit 16 that connects the above-described upper roller brush unit 13 and the lower roller brush unit 14 to the lubricator body 15, and moves the upper roller brush unit 13 and the lower roller brush unit 14 in contact with and away from the tire T. This brush movement unit 16 includes an upper link unit 39 and a lower link unit 40 as link mechanisms that bring the upper roller brush unit 13 close to the tire T while moving the upper roller brush unit downward and bring the lower roller brush unit 14 close to the tire T while moving the lower roller brush unit upward.

The lubricator device 1 of the present embodiment adopts such link mechanisms for the following reason.

That is, in a case of applying the lubrication liquid, when a place where this lubrication liquid is applied includes only the radially inner end surfaces 11 (refer to FIG. 10) of the bead sections 10, lubrication by the lubrication liquid becomes insufficient. Thus, there is sometimes a case where not only inadequate tire installment is caused but also measurement precision of the tire test is deteriorated. Therefore, in the lubricator device 1 of the present embodiment, the lubrication liquid can be applied not only to the radially inner end surfaces 11 of the bead sections 10 but also to the side end surfaces 12 (refer to FIG. 10) of the bead sections 10 provided on upper and lower surfaces of the bead sections 10.

Next, the brush movement unit 16 serving as a characteristic of the present embodiment, and the link mechanisms forming this brush movement unit 16 will be described in detail.

The brush movement unit 16 brings the upper roller brush unit 13 and the lower roller brush unit 14 close to and away from the bead sections 10 of the tire T. The brush movement unit 16 has the upper link unit 39 that supports the upper roller brush unit 13 movably with respect to the lubricator body 15, the lower link unit 40 that supports the lower roller brush unit 14 movably with respect to the lubricator body 15, first and second gears 47a and 47b that interlock the upper link unit 39 and the lower link unit 40 with each other, and a link oscillation cylinder 41 that oscillates (drives) the upper link unit 39 and the lower link unit 40.

The upper link unit 39 is a mechanism that supports the upper roller brush unit 13 in such a manner that the upper roller brush unit 13 is translated in the vertical direction and in the horizontal direction at the same time with respect to the lubricator body 15 while maintaining a predetermined posture such as a posture parallel to the lubricator body 15. In other words, the upper link unit 39 supports the upper roller brush unit 13 oscillatably about horizontal axes S1, S2 with respect to the lubricator body 15 in the arrow A direction and in the arrow B direction shown in FIGS. 3 to 4.

The upper link unit 39 is formed by a pair of upper and lower link members 42, 43 attached to the upper side of the front surface of the lubricator body 15. The pair of upper and lower link members 42, 43 is rod shape members having the same length in the longitudinal direction as each other, in other words, short piece shape members, arranged so as to have a gap slightly shorter than vertical length of the brush frame 18 of the above-described upper roller brush unit 13 in the vertical direction. In the link members 42, 43, base ends on the side of one ends in the longitudinal direction are respectively connected to protruding sections 15c provided on the front surface 15a of the lubricator body 15 oscillatably about the horizontal axes S1, S2. Front ends on the side of the other ends of the link members 42, 43 support the brush frame 18 of the upper roller brush unit 13 oscillatably about horizontal axes S5, S6. Thereby, since the link members 42, 43 are oscillated downward in the arrow A direction of FIG. 3 about the horizontal axes S1, S2 with respect to the lubricator body 15, the upper roller brush unit 13 can be translated so as to come close to the tire T while being lowered. Since the link members 42, 43 are oscillated upward in the arrow B direction of FIG. 4 about the horizontal axes S1, S2 with respect to the lubricator body 15, the upper roller brush unit 13 can be translated so as to go away from the tire T while being raised.

For example, in a state where the upper roller brush unit 13 is close to the side of the lubricator body 15 (state where the upper roller brush unit is away from the tire T) as shown in FIG. 3, the link members 42, 43 of the upper link unit 39 are set in the vertical direction and inclined along the lubricator body 15. In this state, when the parts of the link members 42, 43 of the upper link unit 39 on the side of the other ends (side of the tire T or the upper roller brush unit 13) are oscillated forward (in the arrow A direction of FIG. 3) about the parts on the side of the one ends (side of the lubricator body 15), the link members 42, 43 are set in the horizontal direction. As the link members 42, 43 stand up from the lubricator body 15, a distance from the lubricator body 15 to the upper roller brush unit 13 is extended. Thereby, the upper roller brush unit 13 protrudes forward while being moved downward with respect to the lubricator body 15.

Meanwhile, in a state where the upper roller brush unit 13 is away from the lubricator body 15 (state where the upper roller brush unit is close to the tire T) as shown in FIG. 4, the link members 42, 43 of the upper link unit 39 stand up from the lubricator body 15.

In this state, when the parts of the link members 42, 43 on the side of the other ends (side of the tire T or the upper roller brush unit 13) are oscillated rearward (in the arrow B direction of FIG. 4) about the parts on the side of the one ends (side of the lubricator body 15), the standing link members 42, 43 are brought close to the lubricator body 15 along the lubricator body. As the link members 42, 43 lie down, the distance from the lubricator body 15 to the upper roller brush unit 13 is decreased. Thereby, on the contrary to the above case, the upper roller brush unit 13 retreats rearward while being moved upward. That is, the above-described pair of upper and lower link members 42, 43 forms the upper link mechanism that moves to bring the upper roller brush unit 13 “close to the tire T while moving the upper roller brush unit downward” and bring the upper roller brush unit 13 “away from the tire T while moving the upper roller brush unit upward”.

The lower link unit 40 is a mechanism that supports the lower roller brush unit 14 in such a manner that the lower roller brush unit 14 is translated in the vertical direction and in the horizontal direction at the same time with respect to the lubricator body 15 while maintaining a predetermined posture such as a state parallel to the lubricator body 15. In other words, the lower link unit 40 supports the lower roller brush unit 14 oscillatably about horizontal axes S3, S4 with respect to the lubricator body 15 in the arrow C direction and in the arrow D direction shown in FIGS. 3 to 4.

As well as the upper link unit 39, the lower link unit 40 is formed by a pair of upper and lower link members 44, 45 attached to the lower side of the front surface of the lubricator body 15. The link members 44, 45 of this lower link unit 40 are attached side by side on the lower side of the attachment positions of the link members 42, 43 of the upper link unit 39.

As well as the upper link unit 39, the pair of upper and lower link members 44, 45 provided in the lower link unit 40 has the same length in the longitudinal direction as each other and is arranged so as to have the substantially same gap as the brush frame 28 in the vertical direction. In these link members 44, 45, base ends on the side of one ends in the longitudinal direction are connected to protruding sections 15c provided on the front surface 15a of the lubricator body 15 oscillatably about the horizontal axes S3, S4. Front ends on the side of the other ends of the link members 44, 45 support the brush frame 28 of the lower roller brush unit 14 oscillatably about horizontal axes S7, S8. Thereby, since the link members 44, 45 are oscillated upward in the arrow C direction of FIG. 3 about the horizontal axes S3, S4 with respect to the lubricator body 15, the lower roller brush unit 14 can be translated so as to come close to the tire T while being raised. Since the link members 44, 45 are oscillated downward in the arrow D direction of FIG. 4 about the horizontal axes S3, S4 with respect to the lubricator body 15, the lower roller brush unit 14 can be translated so as to go away from the tire T while being lowered.

It should be noted that although the link member 44 on the upper side of the lower link unit 40 has a rod shape as well as the upper link unit 39, the link member 45 on the lower side has a triangular plate shape. In this link member 45 formed in a triangular plate shape, one apex of three apexes is connected to the front surface 15a of the lubricator body 15, another apex is connected to a side surface of the brush frame 28, and the remaining one apex is connected to a part 41b on the side of a front end (movable side) of the link oscillation cylinder 41 to be described later.

For example, regarding the lower link unit 40, a state where the lower roller brush unit 14 is close to the side of the lubricator body 15 (state where the lower roller brush unit is away from the tire T) as shown in FIG. 3 is considered. In this state, when the parts of the link members 44, 45 provided in the lower link unit 40 on the side of the other ends are oscillated forward (in the arrow C direction of FIG. 3) about the parts on the side of the one ends, the link members 44, 45 are brought into a standing state. As the link members 44, 45 protrude forward, a distance from the lubricator body 15 to the lower roller brush unit 14 is extended, so that the lower roller brush unit 14 is “brought forward while being moved upward”.

Meanwhile, when the parts of both the link members 44, 45 on the side of the other ends are oscillated rearward (in the arrow D direction of FIG. 4) about the parts on the side of the one ends, the standing link members 44, 45 are brought close to the lubricator body 15 along the lubricator body. As the link members 44, 45 lie down, the distance from the lubricator body 15 to the lower roller brush unit 14 is decreased. On the contrary to the forward oscillation, the lower roller brush unit 14 retreats “rearward while being moved downward”. That is, the link members 44, 45 provided in the above-described lower link unit 40 form the lower link mechanism that moves to bring the lower roller brush unit 14 close to the tire T while moving the lower roller brush unit upward and bring the lower roller brush unit 14 away from the tire T while moving the lower roller brush unit downward.

The brush movement unit 16 has the first gear 47a connected to the base end of the link member (link member 43 on the lower side) of the upper link unit 39, and the second gear 47b connected to the base end of the link member (link member 44 on the upper side) of the lower link unit 40. The first gear 47a and the second gear 47b are meshed with each other. The first gear 47a is connected to the base end of the link member 43 so as to be rotated concentrically to the base end about the horizontal axis S2. The second gear 47b is connected to the base end of the link member 44 so as to be rotated concentrically to the base end about the horizontal axis S3.

For example, when the link members 44, 45 of the lower link unit 40 are rotated upward as shown in FIG. 3, the second gear 47b connected to the base end of the link member 44 is rotated in the anti-clockwise direction (arrow C direction), and the first gear 47a meshed with the second gear 47b is rotated in the clockwise direction (arrow A direction) opposite to the rotation direction of the second gear 47b. Thereby, the link member 43 of the upper link unit 39 connected to the first gear 47a is rotated downward together with the other link member 42. When the link members 44, 45 of the lower link unit 40 are rotated downward as shown in FIG. 4, the second gear 47b is rotated in the clockwise direction (arrow D direction), and the first gear 47a meshed with the second gear 47b is rotated in the anti-clockwise direction (arrow B direction) opposite to the rotation direction of the second gear 47b. Thereby, the link member 43 of the upper link unit 39 connected to the first gear 47a is rotated upward together with the other link member 42. In such a way, as shown in FIGS. 3 to 4, by rotating the first gear 47a and the second gear 47b in the opposite directions to each other while meshing the gears with each other, the link member 43 of the upper link unit 39 and the link member 44 of the lower link unit 40 can be oscillated toward the respectively different rotation directions while being interlocked with each other.

The link oscillation cylinder 41 generates drive force for oscillating the upper link unit 39 and the lower link unit 40. The link oscillation cylinder 41 is arranged on the further lower side of the lower link unit 40 on the front surface 15a of the lubricator body 15 in the present embodiment. That is, in the present embodiment, the upper link unit 39 is interlocked with the lower link unit 40 by actions of the above-described gears 47 so as to be oscillated. Thus, the link oscillation cylinder 41 shown in FIGS. 3 to 4 is a mechanism that directly oscillates only the lower link unit 39.

Specifically, the link oscillation cylinder 41 is formed by an air cylinder extendable and contractible along the vertical direction, and can be extended and contracted by regulating pressure of the air supplied by using a pressure regulating valve (not shown) or the like. In this link oscillation cylinder 41, a part 41a on the side of a base end (fixed side) is fixed to the lubricator body 15, and the part 41b on the side of the front end (movable) side) is connected to the link member 45 on the lower side of the lower link unit 40. When the link oscillation cylinder 41 is extended or contracted, the link unit 40 on the lower side is pivoted about the horizontal axes S3, S4, so that the lower link unit 40 can be oscillated.

Next, a method of moving the upper roller brush unit 13 and the lower roller brush unit 14 by using the brush movement unit 16 formed by the above-described upper link unit 39, the lower link unit 40, the link oscillation cylinder 41, and the gears 47, in other words, a lubrication method of the tire T will be described.

Firstly, a procedure of applying the lubrication liquid to the tire T by using the lubricator device 1 will be described.

As shown in FIG. 7, when no lubrication is performed, the lubricator device 1 is accommodated on the lower side of the carrying plane H on the free roller conveyor 3. The above-described air cylinder 37 is not extended, and the lubricator body 15 is lowered to a lowered position.

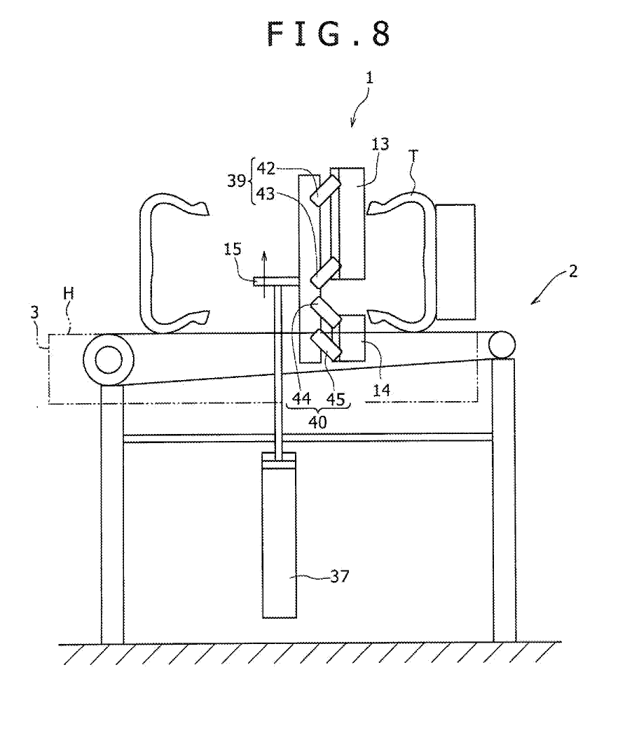

When the air cylinder 37 in which the lubricator body 15 is placed at the lowered position in such a way is extended, the lubricator body 15 is raised to the substantially same height as the tire T, and the lubricator body 15 is raised to a raised position as shown in FIG. 8.

At the raised position shown in FIG. 8, even when the lubricator body 15 is raised to the raised position, the upper roller brush unit 13 and the lower roller brush unit 14 are away from the bead sections 10 of the tire T. Thus, the lubrication liquid cannot be applied. Therefore, by using the brush movement unit 16 next, the upper roller brush unit 13 and the lower roller brush unit 14 are brought close to the side of the tire T.

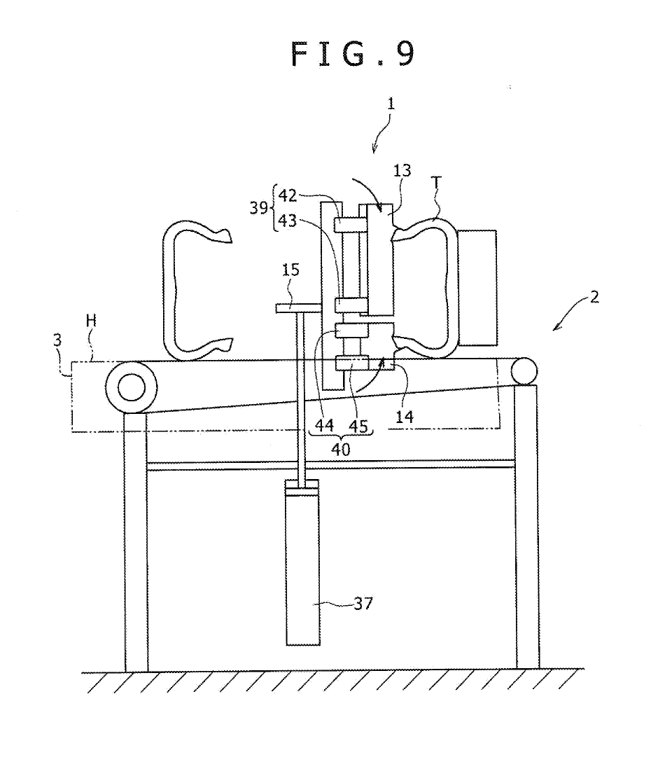

That is, by extending the link oscillation cylinder 41, the lower roller brush unit 14 is brought forward while being moved upward by an operation of the lower link unit 40 as shown in FIG. 3. Meanwhile, by the actions of the above-described gears 47, the upper link unit 39 is rotated downward (in the clockwise direction in FIG. 3) opposite to the lower link unit 40, and the upper roller brush unit 13 is brought forward while being moved downward. As a result, by the brush movement unit 16, a distance between the roller brush units is decreased in the up and down direction while the upper roller brush unit 13 and the lower roller brush unit 14 are respectively moved downward and upward, and at the same time, the roller brush units are moved (brought close) to the side of the tire T, so that a state shown in FIG. 8 is changed to a state shown in FIG. 9.

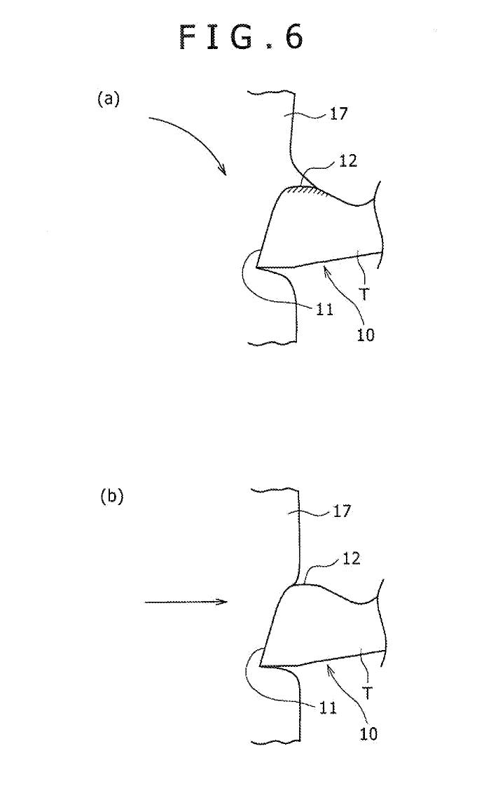

At this time, as shown in an enlarged view of FIG. 6(a), the brush bristles of the brush body 17 of the upper roller brush unit 13 are moved obliquely downward in a curved manner as in an arc arrow, that is, brought close to the radially inner end surface 11 while being lowered to the bead section 10, so as to cover the side end surface 12 of the bead section 10 on the upper side. Thus, by using the upper roller brush unit 13, the lubrication liquid can be applied not only to the radially inner end surface 11 of the bead section 10 on the upper side but also to the side end surface 12 of the bead section 10 on the upper side. Although not shown, the brush bristles of the brush body 14 of the lower roller brush unit 27 covers the side end surface 12 of the bead section 10 on the lower side from the lower side. Thus, the lubrication liquid can be applied not only to the radially inner end surface 11 of the bead section 10 on the lower side but also to the side end surface 12 of the bead section 10 on the lower side.

Meanwhile, as a reference example of the present invention, with reference to FIG. 6(b), in a case where the above brush body 17 is horizontally moved and brought close to the radially inner end surface 11 of the bead section 10, the brush bristles of the brush body 17 come into contact with only the radially inner end surface 11 but almost no contact with the side end surface 12 of the bead section 10 forming the upper surface of the bead section 10. Therefore, it is understood that the lubrication liquid cannot sufficiently be applied to the side end surface 12 of the bead section 10 in this reference example. When the present embodiment shown in FIG. 6(a) above is seen in comparison to this reference example, an operation of bringing the brush body 17 of the upper roller brush unit 13 close to the radially inner end surface 11 of the bead section 10 while moving the brush body downward is performed. Thus, it is understood that the brush bristles of the brush body 17 can surely come into contact with both the radially inner end surface 11 of the bead section 10 and the side end surface 12 of the bead section 10 and apply the lubrication liquid.

Next, a procedure of detaching the lubricator device 1 from the tire T will be described.

At the time of separating the upper roller brush unit 13 and the lower roller brush unit 14 from the tire T, when the link oscillation cylinder 41 is contracted, and as shown in FIG. 4, the lower link unit 40 is rotated downward (in the clockwise direction in FIG. 4) about the horizontal axes S3, S4, the lower roller brush unit 14 retreats from the side of the tire T while being moved downward. Meanwhile, by the actions of the above-described gears 47, the upper link unit 39 is rotated upward (in the anti-clockwise direction in FIG. 3) opposite to the lower link unit 40, and the upper roller brush unit 13 retreats while being moved upward. As a result, by the brush movement unit 16, the distance between the roller brush units is extended in the up and down direction while the upper roller brush unit 13 and the lower roller brush unit 14 are respectively moved upward and downward, and at the same time, the roller brush units are separated from the tire T, so that the state shown in FIG. 9 is changed to the state shown in FIG. 8.

When the lubricator body 15 is lowered from the upper side of the carrying plane H by a procedure reverse to the above-described procedure, the lubricator device 1 is returned to an initial state shown in FIG. 7, so that the lubricator device 1 can be detached from the tire T.

As described above, at the time of bringing the upper and lower roller brush units 13, 14 close to the side of the tire T, when the upper roller brush unit 13 is moved downward and the lower roller brush unit 14 is moved upward, the bead sections 10 of the tire T are nipped between the upper and lower roller brush units 13, 14. That is, the upper roller brush unit 13 is moved downward so as to roll and catch the side end surface 12 of the bead section 10 on the upper side, so that the lubrication liquid can be applied not only to the radially inner end surface 11 of the bead section 10 on the upper side but also to the side end surface 12 of the bead section 10 on the upper side.

When the lower roller brush unit 14 is moved upward so as to roll and catch the side end surface 12 of the bead section 10 on the lower side, the lubrication liquid can be applied not only to the radially inner end surface 11 of the bead section 10 on the lower side but also to the side end surface 12 of the bead section 10 on the lower side.

Therefore, in the lubricator device 1 of the present embodiment including the above-described brush movement unit 16, the lubrication liquid can surely be applied to the radially inner end surfaces 11 of the bead sections 10 of the tire T and the side end surfaces 12 of the bead sections 10, so that a sufficient lubrication operation by application of the lubrication liquid can be obtained. Thus, in a state where lubrication is sufficiently performed, the tire test can be performed with high precision and with favorable reproducibility.

It should be noted that the above-described specific embodiment mainly includes the inventions having the following configurations.

A tire lubricator device of the present embodiment includes an upper roller brush unit that comes into contact with a bead section on the upper side of a tire rotated about a vertical axis and applies a lubrication liquid, a lower roller brush unit that comes into contact with a bead section on the lower side of the tire and applies the lubrication liquid, a lubricator body, and a brush movement unit that connects the upper roller brush unit and the lower roller brush unit to the lubricator body, and moves the upper roller brush unit and the lower roller brush unit in contact with and away from the tire, wherein the brush movement unit has a link mechanism that brings the upper roller brush unit close to the tire while moving the upper roller brush unit downward and brings the lower roller brush unit close to the tire while moving the lower roller brush unit upward.

Preferably, the brush movement unit may include an upper link unit that supports the upper roller brush unit in such a manner that the upper roller brush unit is translated in the vertical direction and in the horizontal direction at the same time with respect to the lubricator body while maintaining a predetermined posture, the upper link unit may have a plurality of link members that connects the upper roller brush unit to the lubricator body, each of the plurality of link members may have a base end supported oscillatably about a horizontal axis with respect to the lubricator body, and a front end that supports the upper roller brush unit oscillatably about a horizontal axis, and by oscillating the link members downward about the horizontal axes with respect to the lubricator body, the upper roller brush unit may be translated so as to come close to the tire while being lowered.

Preferably, the brush movement unit may include a lower link unit that supports the lower roller brush unit in such a manner that the lower roller brush unit is translated in the vertical direction and in the horizontal direction at the same time with respect to the lubricator body while maintaining a predetermined posture, the lower link unit may have a plurality of link members that connects the lower roller brush unit to the lubricator body, each of the plurality of link members may have a base end supported oscillatably about a horizontal axis with respect to the lubricator body, and a front end that supports the lower roller brush unit oscillatably about a horizontal axis, and by oscillating the link members upward about the horizontal axes with respect to the lubricator body, the lower roller brush unit may be translated so as to come close to the tire while being raised.

Preferably, the brush movement unit may include an upper link unit that supports the upper roller brush unit in such a manner that the upper roller brush unit is translated in the vertical direction and in the horizontal direction at the same time with respect to the lubricator body while maintaining a predetermined posture, and a lower link unit that supports the lower roller brush unit in such a manner that the lower roller brush unit is translated in the vertical direction and in the horizontal direction at the same time with respect to the lubricator body while maintaining a predetermined posture, the upper link unit may have a plurality of link members that connects the upper roller brush unit to the lubricator body, each of the plurality of link members may have a base end supported oscillatably about a horizontal axis with respect to the lubricator body, and a front end that supports the upper roller brush unit oscillatably about a horizontal axis, and by oscillating the link members downward about the horizontal axes with respect to the lubricator body, the upper roller brush unit may be translated so as to come close to the tire while being lowered, and the lower link unit may have a plurality of link members that connects the lower roller brush unit to the lubricator body, each of the plurality of link members may have a base end supported oscillatably about a horizontal axis with respect to the lubricator body, and a front end that supports the lower roller brush unit oscillatably about a horizontal axis, and by oscillating the link members upward about the horizontal axes with respect to the lubricator body, the lower roller brush unit may be translated so as to come close to the tire while being raised.

Preferably, the brush movement unit may have a first gear connected to the base end of the link member of the upper link unit, and a second gear meshed with the first gear and connected to the base end of the link member of the lower link unit, and the first gear and the second gear may be meshed with each other in such a manner that the link members of the upper link unit and the link members of the lower link unit are oscillated toward the respectively different rotation directions while being interlocked with each other.

Preferably, the upper roller brush unit may include an upper brush body that comes into contact with the bead section on the upper side of the tire and applies the lubrication liquid, and an upper pipe that supplies the lubrication liquid to the upper brush body, the lower roller brush unit may include a lower brush body that comes into contact with the bead section on the lower side of the tire, and a lower pipe that supplies the lubrication liquid to the lower brush body, and the lubrication liquid may be supplied to the upper brush body and the lower brush body respectively independently via the upper pipe and the lower pipe.

Preferably, a flow regulating valve that regulates a supply amount of the lubrication liquid may be provided in each of the upper pipe and the lower pipe.

1. A tire lubricator device, comprising:
an upper roller brush unit that comes into contact with a bead section on the upper side of a tire rotated about a vertical axis and applies a lubrication liquid;
a lower roller brush unit that comes into contact with a bead section on the lower side of the tire and applies the lubrication liquid;
a lubricator body; and
a brush movement unit that connects said upper roller brush unit and said lower roller brush unit to said lubricator body, and moves said upper roller brush unit and said lower roller brush unit in contact with and away from the tire, wherein
said brush movement unit has a link mechanism that brings said upper roller brush unit close to the tire while moving said upper roller brush unit downward and brings said lower roller brush unit close to the tire while moving said lower roller brush unit upward.

2. The tire lubricator device according to claim 1, wherein
said brush movement unit includes an upper link unit that supports said upper roller brush unit in such a manner that said upper roller brush unit is translated in the vertical direction and in the horizontal direction at the same time with respect to said lubricator body while maintaining a predetermined posture,
said upper link unit has a plurality of link members that connects said upper roller brush unit to said lubricator body,
each of the plurality of link members has a base end supported oscillatably about a horizontal axis with respect to said lubricator body, and a front end that supports said upper roller brush unit oscillatably about a horizontal axis, and
by oscillating said link members downward about the horizontal axes with respect to said lubricator body, said upper roller brush unit is translated so as to come close to the tire while being lowered.

3. The tire lubricator device according to claim 1, wherein
said brush movement unit includes a lower link unit that supports said lower roller brush unit in such a manner that said lower roller brush unit is translated in the vertical direction and in the horizontal direction at the same time with respect to said lubricator body while maintaining a predetermined posture,
said lower link unit has a plurality of link members that connects said lower roller brush unit to said lubricator body,
each of the plurality of link members has a base end supported oscillatably about a horizontal axis with respect to said lubricator body, and a front end that supports said lower roller brush unit oscillatably about a horizontal axis, and
by oscillating said link members upward about the horizontal axes with respect to said lubricator body, said lower roller brush unit is translated so as to come close to the tire while being raised.

4. The tire lubricator device according to claim 1, wherein
said brush movement unit includes:
an upper link unit that supports said upper roller brush unit in such a manner that said upper roller brush unit is translated in the vertical direction and in the horizontal direction at the same time with respect to said lubricator body while maintaining a predetermined posture; and
a lower link unit that supports said lower roller brush unit in such a manner that said lower roller brush unit is translated in the vertical direction and in the horizontal direction at the same time with respect to said lubricator body while maintaining a predetermined posture,
said upper link unit has a plurality of link members that connects said upper roller brush unit to said lubricator body, each of the plurality of link members has a base end supported oscillatably about a horizontal axis with respect to said lubricator body, and a front end that supports said upper roller brush unit oscillatably about a horizontal axis, and by oscillating said link members downward about the horizontal axes with respect to said lubricator body, said upper roller brush unit is translated so as to come close to the tire while being lowered, and
said lower link unit has a plurality of link members that connects said lower roller brush unit to said lubricator body, each of the plurality of link members has a base end supported oscillatably about a horizontal axis with respect to said lubricator body, and a front end that supports said lower roller brush unit oscillatably about a horizontal axis, and by oscillating said link members upward about the horizontal axes with respect to said lubricator body, said lower roller brush unit is translated so as to come close to the tire while being raised.

5. The tire lubricator device according to claim 4, wherein
said brush movement unit has a first gear connected to the base end of said link member of said upper link unit, and a second gear meshed with said first gear and connected to the base end of said link member of said lower link unit, and
said first gear and said second gear are meshed with each other in such a manner that said link members of said upper link unit and said link members of said lower link unit are oscillated toward the respectively different rotation directions while being interlocked with each other.

6. The tire lubricator device according to claim 4, wherein
said upper roller brush unit includes an upper brush body that comes into contact with the bead section on the upper side of the tire and applies the lubrication liquid, and an upper pipe that supplies the lubrication liquid to said upper brush body,
said lower roller brush unit includes a lower brush body that comes into contact with the bead section on the lower side of the tire, and a lower pipe that supplies the lubrication liquid to said lower brush body, and
the lubrication liquid is supplied to said upper brush body and said lower brush body respectively independently via said upper pipe and said lower pipe.

7. The tire lubricator device according to claim 6, wherein
a flow regulating valve that regulates a supply amount of the lubrication liquid is provided in each of said upper pipe and said lower pipe.
